(19) United States
(12) Patent Application Publication
(10) Pub. No.: US 2010/0208064 A1
(43) Pub. Date: Aug. 19, 2010

(54) SYSTEM AND METHOD FOR MANAGING VIDEO STORAGE ON A VIDEO SURVEILLANCE SYSTEM

(75) Inventors: Lipin Liu, Belle Meade, NJ (US); Hasan Timucin Ozdemir, Plainsboro, NJ (US); Kuo Chu Lee, Princeton Junction, NJ (US)

Correspondence Address: GREGORY A. STOBBS, 5445 CORPORATE DRIVE, SUITE 400, TROY, MI, 48098, US

(73) Assignee: Panasonic Corporation, Osaka (JP)

(21) Appl. No.: 12/496,757

(22) Filed: Jul. 2, 2009

Related U.S. Application Data
(60) Provisional application No. 61/153,906, filed on Feb. 19, 2009.

(51) Int. Cl. H04N 7/18; H04H 60/33; H04N 7/26

(52) U.S. Cl. 348/143; 725/13; 386/124; 348/E07.085; 386/E05.003

(57) ABSTRACT

A system and method for managing video storage on a video surveillance system is disclosed. The system calculates an importance score for a video segment based on a weighted average of multiple scores corresponding to the video event. The multiple scores include an event correlation score correlating a video event with a plurality of other video events, an abnormality score indicating the abnormality of the observed event, a user entered score, a score relating to the number of times a specific location was visited by a moving object, the amount of times a video has been retrieved, and a predicted future storage space. The importance score may be used to determine a video retention operation, such as retaining the video event, purging the video event, reducing the video quality of the event, or storing the video in mix-reality format.

### CROSS-REFERENCE TO RELATED APPLICATIONS

This application claims the benefit of U.S. Provisional Application No. 61/153,906, filed on Feb. 19, 2009. The entire disclosure of the above application is incorporated herein by reference.

### FIELD

The present disclosure relates to video surveillance systems. More particularly, the present disclosure relates to the management of video storage using machine learning techniques and data mining techniques.

### BACKGROUND

One of the major problems in surveillance recording is not enough storage space for stored video recordings. As multiple video cameras, maybe hundreds, survey an area 24 hours a day, seven days a week, video surveillance systems will run out of space regardless of how big a network of storage arrays are. Large scale surveillance system owners are faced with the onerous task of managing alarm and video files compiled by the surveillance system. With literally thousands of hours of footage, this task becomes daunting for any business owner. Multiplying the problem, government regulations require many businesses to store their video files for up to three months, or even longer in some circumstances.

As video surveillance systems are becoming more automated, these systems may be configured to record alarm triggering events, such as abnormal detected behavior. For example, in an industrial workplace setting, a video surveillance system may determine that an employee was walking in a restricted area before injuring himself. These systems may be capable of automatically detecting that an abnormal path was taken and may associate an abnormality score with the event. These systems introduce additional work for system managers as security personnel must decide what abnormal events to keep in storage, and which abnormal events to purge from the system.

The security and surveillance industries provide many solutions to deal with the problems associated with widespread video storage demand. For example, an ever increasing trend is to replace analog cameras with digital cameras, whereby each camera may have its own expandable memory. Additionally, these cameras may configured so that they are not recording unless motion is detected by the camera.

The above-identified approaches may temporarily mitigate the problems associated with storing large amounts of video files. These approaches, however, do not provide an automated and efficient means to directly deal with the problems associated with managing the storage and retention of video files. Thus, there is a need for a system that is able to store as many relevant video events as possible, while at the same time is able to purge the system of as many irrelevant video events as possible.

This section provides background information related to the present disclosure which is not necessarily prior art.

### SUMMARY

This section provides a general summary of the disclosure, and is not a comprehensive disclosure of its full scope or all of its features.

A system for managing a plurality of stored video segments corresponding to video events captured by a video surveillance system is disclosed. The system comprises a video data store that stores the plurality of video segments. The system further comprises a scoring module that generates an importance score based on an event correlation score corresponding to a correlation between a video segment and other video segments having video events that correlate spatially and temporally to the video event corresponding to the video segment to be scored. The system also comprises a video management module that performs a video retention operation on the given video segment based in part on the importance score generated by scoring module.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a functional block diagram of a surveillance system according to the present disclosure;

FIG. 2 is a functional block diagram of a control module according to the present disclosure;

FIG. 3 is a schematic illustrating exemplary field of view of exemplary sensing devices according to the present disclosure

FIG. 4 is a functional block diagram of a content importance score calculator;

FIG. 5 is a flow diagram of an exemplary method for calculating an event correlation score according to the present invention; and

FIG. 6 is a functional block diagram of a video management module according to the present invention.

Corresponding reference numerals indicate corresponding parts throughout the several views of the drawings.

### DETAILED DESCRIPTION

Example embodiments will now be described more fully with reference to the accompanying drawings.

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

The following disclosure presents a method and system for efficiently managing video surveillance footage using machine learning techniques and video behavior mining. The proposed system and method allows video recorders and storage arrays to automatically retain or purge video files based on a number of different considerations, including event correlations (described below). The proposed system may implement guided and unguided learning techniques to more efficiently automate the video storage clean-up process and data mining techniques to uncover statistics corresponding to video events and a user of the system. The system may be further operable predict the expected storage requirements by modeling the expected number of relevant events and their related storage space demand.

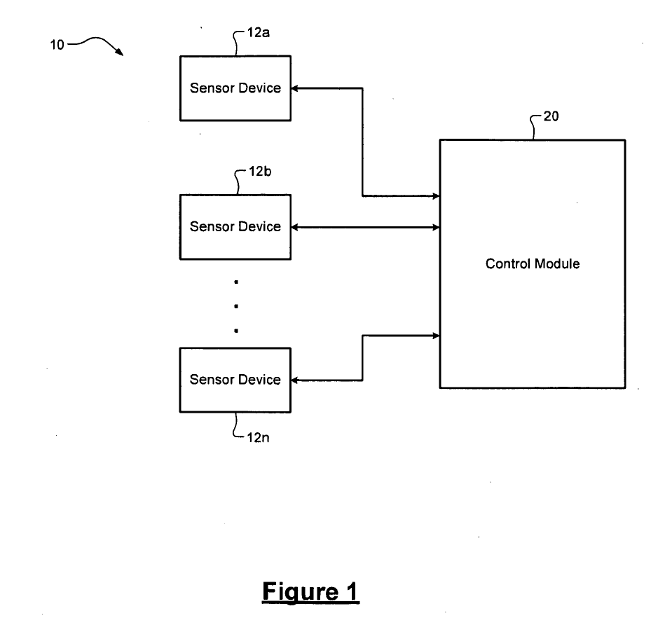

Referring to FIG. 1, an exemplary video surveillance system 10 is shown. The system may include sensing devices (video cameras) 12a-12n, and a control module 20. Video cameras 12a-12n record motion or image data relating to objects and communicate the image data to control module 20. The control module can be configured to score the recorded event and may decide to store the video associated with the event. Control module 20 can also manage a video retention policy, whereby control module 20 decides which videos should be stored and which videos should be purged from the system.

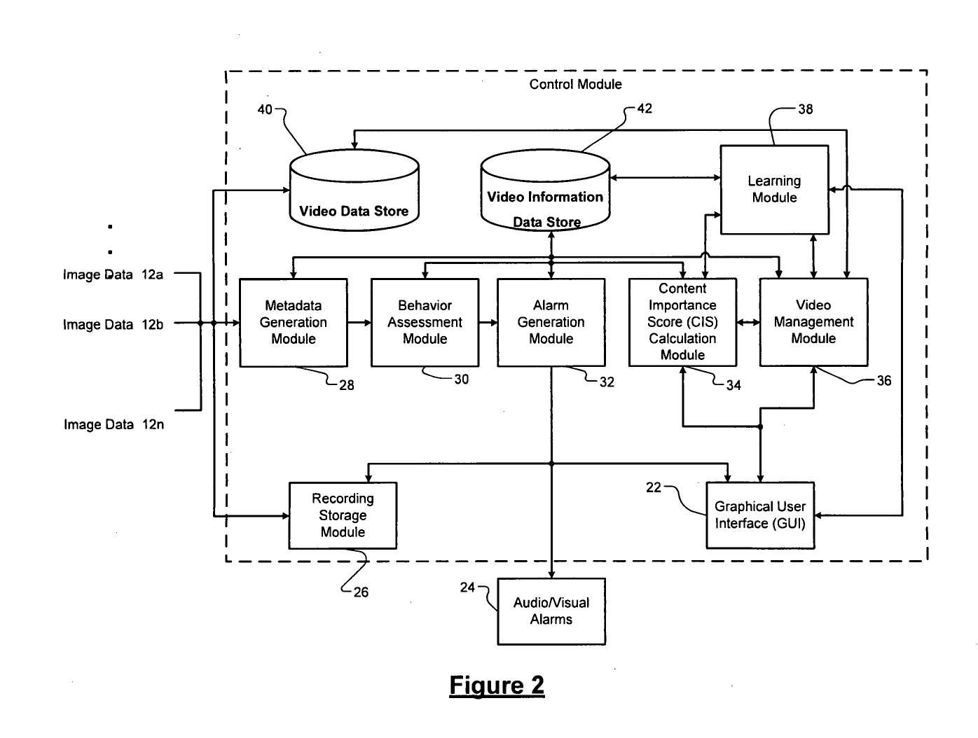

FIG. 2 illustrates in greater detail exemplary control module 20. Control module manages the video surveillance system. Control module 20 is responsible for scoring a video event and for deciding when to retain a video event and when to purge a video event. Control module 20 may be further operable to predict the future behavior of a moving object. Control module 20 can include, but is not limited to, a metadata generation module 28, a behavior assessment module 30, an alarm generation module 32, a content importance scoring (CIS) calculation module 34, a video management module 36, a learning module 38, a video data store 40, and a video information data store 42. Control module may also include or communicate with a graphical user interface (GUI) 22, audio/visual (A/V) alarms 24, and a recording storage module 24. Accordingly, control module 20 may also generate an alarm message for at least one of the GUI 22, the A/V alarm 24, and the recording storage module 24.

As discussed, the sensing devices 12a-12n, may be video cameras or other devices that may capture motion, such as an infrared camera, a thermal camera, a sonar device, or a motion sensor. For exemplary purposes, sensing devices 12a-12n will be referred to as video cameras that capture video or motion data. Video cameras 12a-12n may communicate video and/or motion data to metadata generation module 28 or may directly communicate video to video data store 20. Video cameras 12a-12n can also be configured to communicate video to video data store 20 upon a command from recording storage module 26 to record video. Such a command can be triggered by alarm generation module 32. It should be understood that the video cameras 12a-12n may be digital video cameras or analog cameras with a mechanism for converting the analog signal into a digital signal. Video cameras 12a-12n may have on-board memory for storing video events or may communicate a video feed to control module 20.

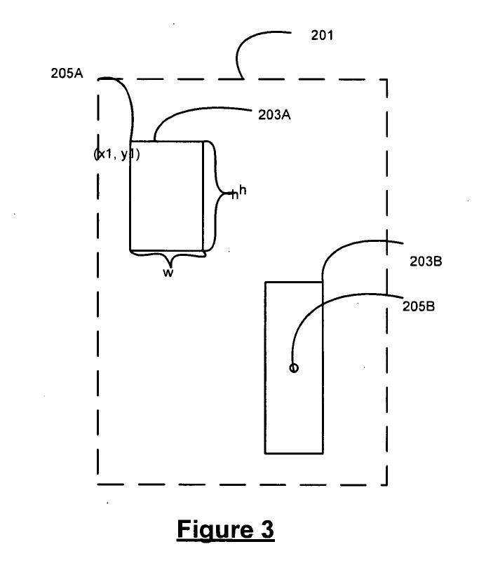

Video cameras 12a-12n may be configured to record motion with respect to a target area or a grid within the field of view of the device. For example, FIG. 3 provides an example of a field of view of a camera having pre-defined target areas. Referring now to FIG. 3, an exemplary field of view 201 of one of the video cameras 12a-12n is shown. The field of view 201 may include multiple target areas 203A and 203B. Target area 203B may include a upper left corner point coordinates (x1, y1) 203A, a height h, and a width w. Thus, information relating to each target area may include, the upper left corner point coordinates in image plane, the height of the target area and the width of the target area. It is appreciated that any point may be chosen to define the target area, such as the center point, lower left corner point, upper right corner point or lower right corner point. Furthermore, target area 203B may include additional information, such as a camera ID number, a field of view ID number, a target ID number and/or a name of the target area (e.g. break room door). It can be appreciated that other additional information that may be relevant to the target area may also be stored.

Target area information may be stored in a table. For example only, an exemplary table for storing target area definitions is provided:

| | | | | | | | |
|---|---|---|---|---|---|---|---|
| Camera | Field of View | Target Area | | | | | |
| ID # | ID # | ID # | x | y | w | h | Target Name |

Referring back to FIG. 2, exemplary metadata generation module 28 receives the image data from video cameras 12a-12n. Metadata generation module 28 generates metadata based on the image data from video cameras 12-12n. For example only, the metadata may correspond to a trajectory of an object sensed by video cameras 12a-12n. The metadata may be defined with respect to one or more target areas or with respect to a grid. Metadata generation module 28 may use techniques known in the art to generate metadata based on received image data. Metadata can include, but is not limited to, a video camera identifier, an object identifier, a time stamp corresponding to an event, an x-value of an object, a y-value of an object, an object width value, and an object height value. Metadata may also include data specific to the object, such as the object type, an object bounding box, an object data size, and an object blob data. Metadata generation module 28 may include a pre-processing sub-module (not shown) to further process motion data.

The pre-processing sub-module may generate additional object information based on the metadata. For example, the additional object information may include, but is not limited to, the velocity of the object, the acceleration of the object, and whether the observation of the object is an outlier. An outlier may be defined as an observation of an object whose motion is not “smooth.” For example, an outlier may be a video of a person who repeatedly jumps while walking. In other words, pre-processing sub-module may recognize a non-conforming segment of the trajectory, i.e. the jump, and may then classify the object as an outlier. The pre-processing module may use known techniques in the art for processing video metadata.

Exemplary behavior assessment module 30 receives metadata corresponding to an observed event and generates an abnormality scored based on the observed event by using scoring engines. Scoring engines (not shown) receive video data or motion data corresponding an observed event and compare the motion to normal motion models in order to determine a score for the motion. For example only, in a retail store setting, a camera may observe a person pacing around the same area for an extended period of time. Depending on the type of scoring engine, e.g. a loitering scoring engine, the scoring engine may recognize this as suspicious behavior based on a set of rules defining loitering and a set of normal motion models. Normal motion models are models that may be used as references when analyzing a video event. To the extent an observed event comports to the motion models, the observed event may have a score corresponding to a “normal” event. Appendix A of U.S. patent application Ser. No. 11/676,127 describes a variety of different scoring engines and scoring algorithms. Application Ser. No. 11/676,127, is herein incorporated by reference. Behavior assessment module 30 may also be configured to predict the motion of an object based on the observed motion of the object. The predicted motion of the object may also be scored by one or more scoring engines. It may be useful to use a predictive behavior assessment module 30 so that the system may anticipate what events to record and store in video data store 40. It is appreciated that multiple scoring engines may score the same event. The scores of observed events or predicted motion may be communicated to an alarm generation module 32.

Alarm generation module 32 receives an abnormality score from behavior assessment module 30 and may trigger one or more responses based on said score. Exemplary alarm generation module 32 may send an alert to audio/visual alarms 24 that may be near the observed event. Also, an alarm notification may be communicated to a user via a graphical user interface (GUI) 26. The GUI 26 may also receive the actual video footage so that the user may acknowledge the alert or score the alert. Such user notification and user response may be used by learning module 38 to fine tune the system and the setting of various parameters. Alarm generation module 32 may also send an alert to recording storage module 26. Recording storage module 26 directs one or more of video cameras 12a-12n to record directly to video data store 40. Referring back to the example of the loiterer, the retail shop may want to record any instance of someone loitering around a certain area so that a potential shoplifting incident may be recorded and stored on video. Thus, when an alert is sent to recording storage module 26, the alert will cause the incident to be stored in video data store 40. When a video event causes an alarm, the fact that the event corresponding to an alarm may be stored in video information data store 42. It should be understood, however, that in an alternative embodiment, every recorded video event, regardless of score may be stored in video data store 40.

Content importance score (CIS) calculation module 34 may be configured to score individual stored video events so that important video events may be retained in video data store 40 and unimportant video events may be purged from video data store 40. CIS calculation module 34 may be configured to run at predetermined times, e.g. every night, or may be configured to continuously run whereby it continuously is evaluating video events stored in video data store 40. CIS calculation module 34 communicates with video information data store 42, video data store 40 and learning module 38 to determine the relative importance of each stored video event. CIS calculation module 34 scores stored video events based on a weighted average of various factors. Exemplary factors may include, but are not limited to, an abnormality score of an event (or the maximum abnormality score of an event if captured by multiple cameras), a retention and usage score of an event, an event correlation score of an event, an alarm acknowledgement and feedback score of an event, an alarm target score of an event, and a prediction storage score. The weights used for weighted averaging may be user defined or may be fine tuned by learning module 38. CIS calculation module 34 is described in greater detail below. CIS calculation module 34 passes a calculated CIS score to video management module 36.

Video management module 36 receives a CIS score corresponding to a video event and video information corresponding to an event and decides what to do with the video based on pre-defined rules and rules developed by learning module 38. For example, video management module 36 may decide to purge a video event from video data store 40 based on a CIS score corresponding to the video event. Video management module 36 may also be configured to store video events in a mix reality format, discussed in greater detail below. Video management module 36 is described in greater detail below.

Learning module 38 monitors various aspects of the system and mines tendencies of users as well as the system to determine how to fine tune and automate the various aspects of the system. For example, Learning module 38 may monitor the decisions made by a security manager when initially maintaining the video data store 40. Learning module 38 may keep track of the types of video events that are retained and the types of video events that are purged. Furthermore, learning module 38 may further analyze features of the videos that are purged and stored to determine what a human operator considers to be the most important factors. For example only, learning module 40 may determine after analyzing thousands of purged and retained events, that the weights should be adjusted to give a greater weight to event correlation score. Learning module 40 may also determine after analyzing the usage of video events that certain videos may be stored in lower quality or at a lower frame rate than other video events. Learning module 38 is described in greater detail below.

Video data store 40 stores video events. Video data store 40 may be any type of storage medium known in the art. Video data store 40 may be located locally or may be located remotely. Video events may be stored in M-PEG, M-JPEG, AVI, Ogg, ASF, DivX, MKV and MP4 formats, as well as any other known or later developed formats. Video data store 40 receives video events from sensing devices 12a-12n, and receives read/write instructions from video management module 36 and recording storage module 26.

Video information data store 42 stores information corresponding to the video events stored in video data store 40. Information stored for a video event may include, but is not limited to video motion metadata, an abnormality score or scores associated with the event or events captured by the video footage, operation log metadata, human operation models, behavior mining models, mining summary reports, whether or not a video event has been flagged for retention or deletion, and other information that may be relevant. It will become apparent as the system as described what types of data may be stored in video information data store 42.

Exemplary video information data store 42 may store the following categories of data: metadata data, model data, and summary reports. Metadata data may include video object metadata related to an object in a video event, video blob data relating to video blob content data, score data relating to behavioral scores for a video event, trajectory data relating to a trajectory of an object observed in an event and alarm data relating to statistics that were used to determine the necessity of an alarm. Models may include a direction speed model relating characterizing the speed of a model, an occurrence acceleration model relating to a video mining acceleration model, an operation model relating to a human operation model, and a prediction model relating to a storage prediction model. Summary reports may include a trajectory score summary relating to a score for a trajectory, an event summary relating to the behavior of an object, a target occurrence summary relating to the behavior of an object as it approaches a target and an activity summary relating to the activity count distribution of a data cube. The foregoing list is merely an example of the types of data stored in exemplary video information data store 42. It should be understood that other data types may be included in said data store 42 or replace types of data previously discussed.

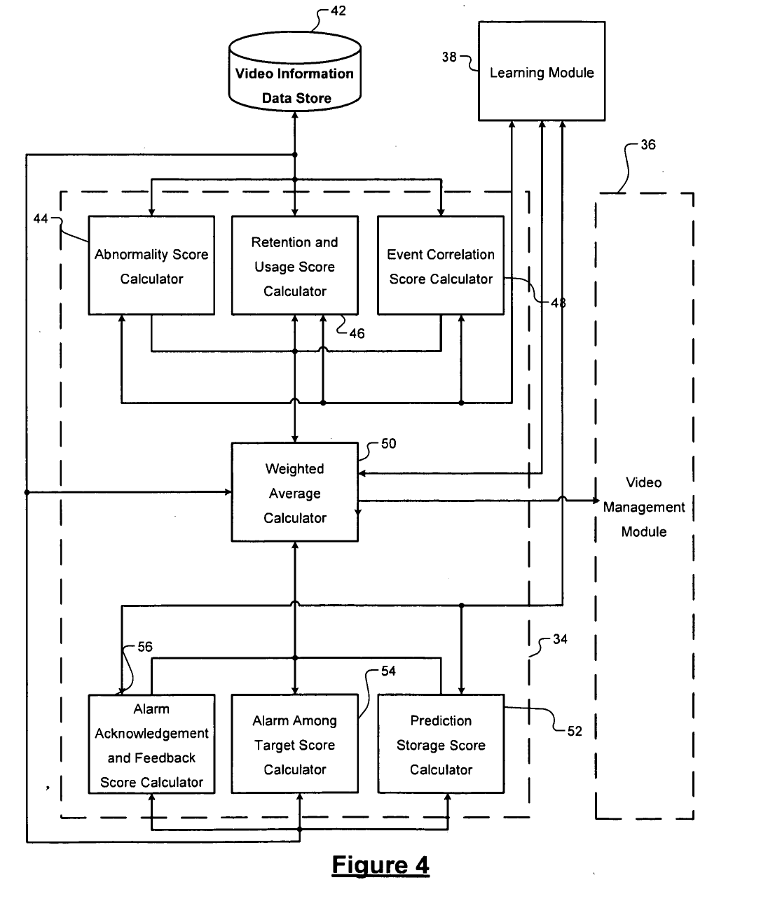

Referring now to FIG. 4, CIS calculation module 34 is illustrated in greater detail. CIS calculation module 34 receives data from video information data store 42 relating to a video event and calculates a content information score. The content information score is used by video management module 36 to determine how a video entry will be handled. CIS calculation module 36 collects various scores relating to a video entry and produces a weighted average of the scores. Initially weights w₁ through wᵢ may be provided by a user. However, as learning module 38 collects more data on the user's tendencies and preferences, the weights may be adjusted automatically by learning module 38. Weights provided by the user may reflect empirical data on which types of video events should be retained in a system or may be chosen by an expert in the field of video surveillance.

Exemplary CIS calculation module includes an abnormality score calculator 44, a retention and usage score calculator 46, an event correlation score calculator 48, an alarm acknowledgment and feedback (AF) score calculator 56, an alarm among target score calculator (AT) 54 and a prediction storage (PS) score calculator 52. It should be appreciated that not all of the above-referenced score calculators are necessary and other score calculators may be used in addition or in place of the listed score calculators. Furthermore, CIS calculation module includes a weighted average calculator that receives a plurality of scores from various score calculators and determines the weighted average of the scores.

The following describes exemplary score calculators in greater detail. Abnormality score calculator receives abnormality scores either from video information data store 42 or from the behavior assessment module 32 directly. As discussed behavior assessment module 32 implements one or more scoring engines that score a video event. Types of scoring engines include approaching scoring engine, counting scoring engine, cross over scoring engine, fast approaching scoring engine, loitering scoring engine and speeding scoring engine. Other types of scoring engines that may be used are disclosed in Appendix A of U.S. patent application Ser. No. 11/676,127. Abnormality score calculator 44 may receive the scores in unequal formats, and thus could be configured to normalize the scores. Scores should be normalized when the scores provided by individual scoring engines are on different scales. Known normalization methods may be used. Alternatively, a weighted average of the scores may be calculated by abnormality score calculator. In an alternative embodiment, abnormality score calculator merely receives a score from video information data store 44 that represents a normalized score of all relevant scoring engines of behavior assessment module 32.

Retention and usage score calculator 46 receives statistics relating to the retention time and usage of a video event from video information data store 42 and calculates a score based upon said statistics. Retention time corresponds to amount of time the stored video event has been in the system. The usage occurrence corresponds to the number of times a video event has been retrieved or accessed. A retention and usage score may be calculated as the weighted average of the ratio of the retention time of a video event and the retention time of the longest archived video event stored in the system and the ratio of the usage occurrence of a stored video event to the total usage occurrences of all video events stored in the system. Thus, in an exemplary embodiment the retention and usage score for a particular video may be expressed by the following equation:

$$RU = {w}_{1} ( \frac{{R}_{i}}{{RT}_{ci}} ) + {w}_{2} ( \frac{{U}_{i}}{{UT}_{ci}} )$$

where RU is the retention and usage score of a video event i, where R is the retention time of the video event, RT is retention time of the longest archived event, where U is the number of usage occurrences of the video event, and UT is the total amount of usage occurrences for all stored video events. Weights w₁ and w₂ can be predefined by a user and may be updated by learning module 38. Alternatively, the equation may be divided by the amount of video events stored in the system. It is readily understood that other equations may be formulated in accordance with the principles disclosed.

Event correlation score calculator 48 receives video data relating to the objects observed in a video event and the time stamps of a video event and calculates a correlation score based on the video data and video data of spatio-temporal neighbors of the video event. It is envisioned that in some embodiments event correlation score calculator 48 may function in two modes, a basic calculation mode or an advanced calculation mode. In the basic calculation mode, only time between events and distance between objects is used in the calculation. In the advanced mode, event correlation score calculator 48 may further take into account alarm types associated with an event, object types observed in each event, behavior severity of each event, and whether or not objects appeared in a spatio-temporal sequence of events.

In a video event, an object will be at a certain location at a certain time. Event correlation score calculator will base an event correlation score on the video event observed from a first camera, and the video events observed by a group of cameras 12a-12i, which may be a subgroup of cameras 12a-12n. The group of cameras 12a-12i may be selected by the designer of the surveillance system based on some sort of relationship. For example, the cameras 12a-12i may be located close to one another, the cameras 12a-12i may monitor critical points, or the cameras 12a-12i may follow a specific path. It should be understood in some video surveillance systems the subgroup of cameras 12a-12i, may be the entire group of cameras 12a-12n.

The event correlation score calculator 48 will calculate correlations for a video event with other video events that occurred within a predetermined time frame. For example, event correlation score calculator may look at all events observed by cameras 12a-12i one hour before and one hour after the video event whose event correlation score is being calculated.

After retrieving all pertinent video events and corresponding video information, event correlation calculator 48 will calculate an event correlation score for the video event by calculating the distances between objects in the video event and objects observed in the spatio-temporal neighbors of the video event and by calculating the differences in time between the video events. Event correlation calculator may identify each object in the video event to be scored and identify all the objects observed in the spatio-temporally neighboring video events and calculate the distances between the objects. Furthermore, event correlation calculator can calculate the maximum distance possible between objects observed in two video events or within the field of view coverage of multiple cameras. Event correlation score calculator 48 may also determine the duration of time of each of the video events and the total time of alarm events during a time window corresponding to the video events being analyzed. It should be noted that some of the objects may be the object initially viewed in the video event and that some video events may occur simultaneously with other video events. Based on the data determined by event correlation score calculator 48, a event correlation score may be calculated. An exemplary embodiment of event correlation score calculator 48 may use the following equation to calculate the event correlation score of a particular event:

$$EC = {w}_{1} * ( {\sum }_{i = 1 ∼ n - 1} \frac{{D}_{i}}{{DM}_{ck}} ) / ( n - 1 ) + {w}_{2} * ( {\sum }_{e = 1 ∼ n - 1} \frac{{AN}_{e}}{{AN}_{t}} ) / ( n - 1 )$$

where w₁ is the weight coefficient for spatial factor calculation, w₂ is the weight coefficient for temporal factor, Dᵢ is the distance between two alarm objects in 3D world coordination for all i=1 to n−1, n is the total alarm objects during the moving time window T, DM_{ck} is the maximum objects distance between camera c and camera k in 3D world coordination that objects ever appeared in these cameras, ANₑ is time duration of this alarm event, and ANₜ is the total time of alarm during the time window T. The weights are initially assigned by a user and may be adjusted by the user or learning module 38. It should be noted that for a group of cameras 12a-12i, the maximum distances between a pair of cameras (DM_{ck}) may be stored in video information data store once initially determined. Also, ANₜ may be equal to the predefined time frame that is used by event correlation calculator 48. It is readily understood that other equations may be formulated in accordance with the principles disclosed.

As previously mentioned, in some embodiments event correlation score calculator 48 may operate in an advanced mode. When operating in an advanced mode, event correlation score calculator 48 is configured to calculate advanced data mining statistics based on account alarm types associated with an event, object types observed in each event, behavior severity of each event, and whether or not objects appeared in a spatio-temporal sequence of events, in addition to distance and time considerations. The advanced score calculator may calculate a Pearson product-moment correlation coefficient using the above-listed considerations as data samples.

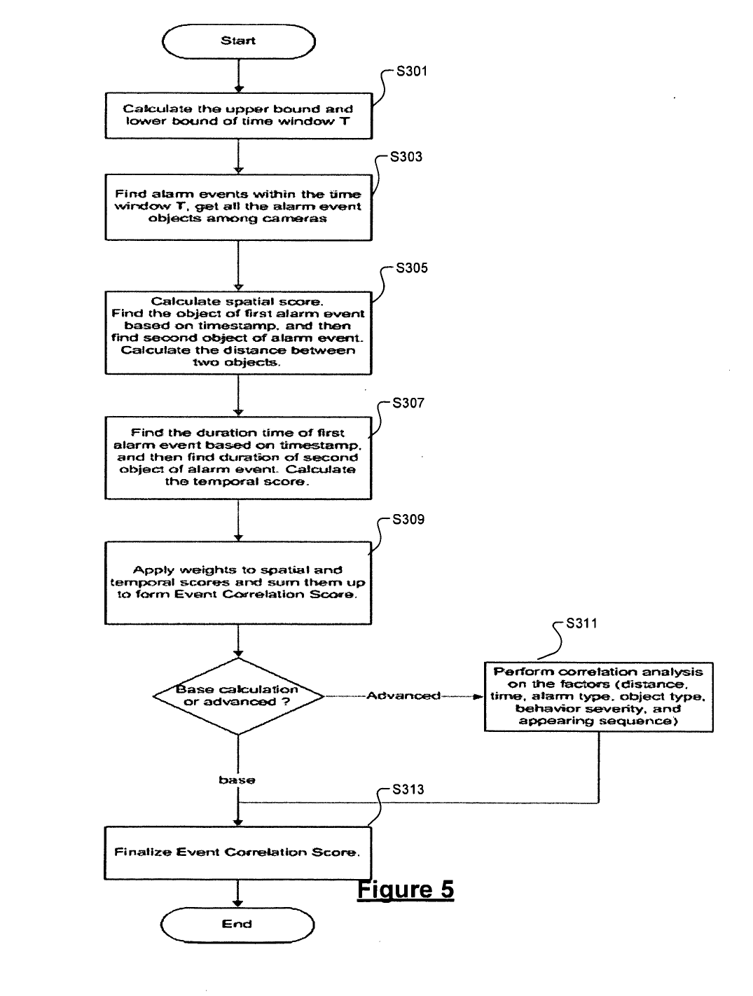

FIG. 5 depicts an exemplary method for determining an event correlation score. At S301 event correlation score calculator 48 calculates the upper bound and lower bound time window T. The upper bound and lower bound time window may be chosen by the user, may be based on what type of video event is being analyzed, or may be dependent on a number of factors such as the camera observing the event, the date or time of the event, the abnormality score of the event, or another factor having corresponding data stored in video information database 42. The time window T will define what video events are candidates to be correlated with the video event being scored. At step S303, event correlation score calculator 48 will retrieve all video events observed by the video cameras 12a-12i (the sub group of cameras discussed above) that were recorded in the time window T.

At step S305, event correlation score calculator 48 will calculate a spatial score for the video event. Event correlation score calculator 48 will identify an object in the video event being scored and determine a time stamp corresponding to the location of the object. It will then find a second object in a second alarm event and calculate the distances between the objects at the time corresponding to the timestamp. Event correlation score calculator 48 will then divide the distance between the objects by the maximum possible distance between the objects. The maximum possible distance is the distance between the two points in the fields of view of the cameras furthest apart from one another. Event correlation score calculator 48 will do this for all objects appearing in the events selected at step S303 and sum the results of each iteration. The sum of scores may be divided by (n−1), where n is the number of video events analyzed.

At step S307, event correlation score calculator 48 will calculate the temporal score for the video event. Event correlation score calculator 48 may determine the duration of one of the video events and divide the duration by total time of alarm events occurring during the time window T. Event correlation score calculator 48 may perform the above stated step iteratively for each video event selected at step S303 and sum the total. The sum total may be divided by (n−1).

At step S309, the results of S305 and S307 are multiplied by weights w₁ and w₂, where w₁ is the weight coefficient for spatial factor calculation, w₂ is the weight coefficient for temporal factor, and the two totals are added together.

If event correlation score calculator 48 is operating in an advanced mode, a correlation analysis may be performed on other factors such as alarm type, object type, behavior scores and whether the events appear in sequence at S311. If the event correlation score calculator 48 is operating in a basic mode, S311 is not performed and the score is finalized. The foregoing method is exemplary in nature and it is readily understood that other methods may be formulated in accordance with the principles disclosed.

It is noted that correlated video events may be used to influence the retention of another video. For example, a first video observed by a first camera at a first time stored in video data store 40 depicts a man setting a garbage can in fire and a second video observed by a second camera at a second time depicts the man getting into a car and driving off. The first video event will likely be retained because of the severity of the behavior, while the second video may be purged due to its relative normalness. If event correlation score calculator 48 determines that the two events are highly correlated, a pointer from the video information relating to the first video event may point to the second video event or vice versa to indicate that if the first video event is retained, then so should the second video event.

Alarm acknowledgment and feedback (AF) score calculator 56 scores the user's feedback of a video event. The AF score is in the form of a user feedback score, which is stored in the video data. The user will acknowledge an alarm corresponding to a video event and assign an evaluation score for the video. For example, a user may see the video event corresponding to a person setting a garbage can on fire and may score the event as a 5 on a scale of 1 to 5, wherein 1 is an irrelevant video and a 5 is a highly relevant video. The same user may see a person walking her dog in a video event and may score the event as a 1. The AF score calculator may be configured to normalize the user's feedback score before providing a score to weighted average calculator. It is envisioned that learning module 38 may be able to provide an AF score for a video event once it has enough training data to make such a determination.

Alarm among target score calculator 54 analyzes the sequence flow observed by a camera or across multiple cameras. As discussed, a field of view of a camera 12a-12n may include one or more predefined target areas. When an object moves to a target area, metadata generation module 28 may indicate the happening of such movement. Furthermore, metadata generation module 28 may indicate a sequence of targets visited by a moving object. A sequence of visited target areas may be referred to as an occurrence of a sequence flow. For example, if a field of view of a camera has three predefined target areas, TA1, TA2, and TA3, then an occurrence of a sequence flow may be an object visiting TA1 and TA2 or TA2 and TA3. Alarm among target score calculator 54 analyzes how common a sequence flow is. The alarm among target score (AT) may be expressed as:

$$AT = \frac{{O}_{Tot \vert VE}}{{\sum }_{1}^{n} {O}_{T ( i )}}$$

where O_{Tot|VE} is the total amount of times a particular sequence corresponding to the video event has occurred and where O_{T(i)} is the occurrence count of an object approaching to a target i. In other words, O_{T(i)} is the total amount of target visits. Thus, AT can be viewed as how common a particular sequence flow is as compared to all sequence flow.

Prediction storage score calculator 52 predicts the amount of storage space that is needed by a particular camera 12a-12n or a particular event observed by a camera 12a-12n. Prediction storage score calculator 52 uses historical data relating to a camera to make a determination. This may be achieved by treating the past storage requirements of the cameras 12a-12n as a neural network. Learning module 38 may analyze the storage requirements of the cameras 12a-12n by looking back at previous time periods. Based on the past requirements of each camera 12a-12n individually and in combination, learning module 38 can make a prediction about future requirements of the cameras 12a-12n. Based on the predicted storage requirement for a camera 12a-12n, the scoring of an event may be expressed as:

$$PS = \frac{{SR}_{i}}{{MSR}_{C l}}$$

where PS is the predicted storage score for a particular camera, where SR is the predicted storage requirement for a camera i, and where MSR is the maximum storage space available to all cameras 12a-12n. Alternatively, an individual event may have its own score, wherein the predicted storage score for an individual event may be expressed as:

$${PS}_{event} = \frac{{SR}_{i}}{{MSR}_{C l}} * \frac{1}{n}$$

where n is the total amount of stored events from a camera i.

Weighted average calculator 50 may receive all the scores from the score calculators and may perform a weighted average of the scores to calculate a content importance score (CIS score) for each event. The CIS score is communicated to the video management module 36 and to the video information data store 42. Weighted average calculator 50 may include a score normalizing sub-module (not shown) that receives all the scores and normalizes the scores. This may be necessary depending on the equations used to calculate the score, as some scores may be on a scale of 0 to 1, others may be on scales of 1-100 and other score ranges may include negative numbers. Furthermore, a CIS score that suggests that a video should be retained may have a positive correlation with certain scores and a negative correlation with others. Thus, a score normalizing sub-module may be used to ensure that each score is not given undue weight or not enough weight and to ensure that all scores have the same correlation to the CIS score. Alternatively, score normalization may be performed in the individual score calculators.

Weighted average calculator 50 calculates the weighted average of the scores. The weighted average of the scores may be expressed as:

CIS=(w₁*AB+w₂*RU+w₃*EC+w₄*AF+w₅*AT+w₆*PS+w₇*UP)/Σwᵢ

where w₁-w₇ are the weights corresponding to each score, and UP is a user defined parameter or parameters. The weights w₁-w₇ are initially selected by a user, but may be optimized by learning module 38 as learning module 38 is provided with more training data.

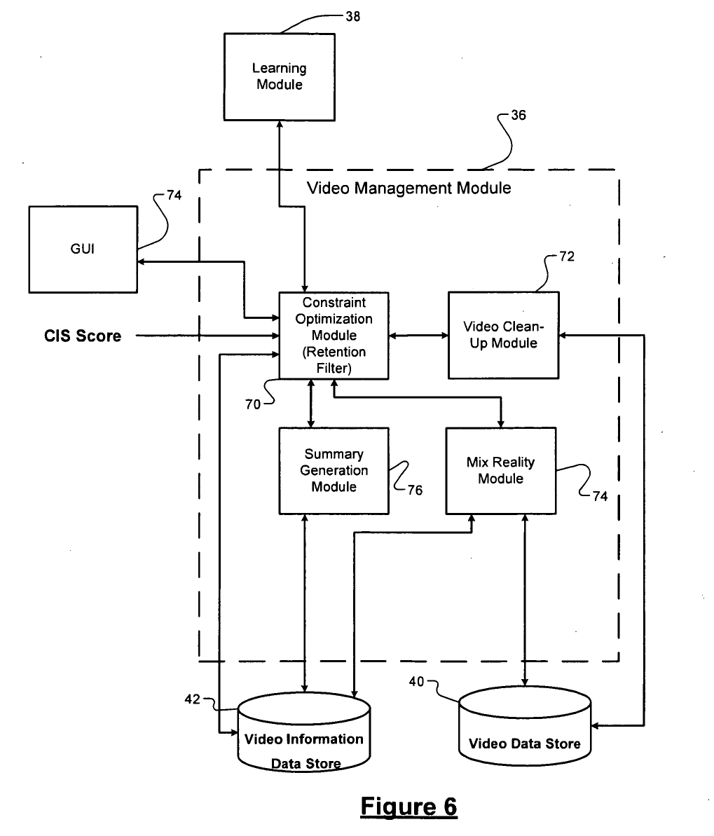

Referring now to FIG. 6, video management module 36 is illustrated in greater detail. Video management module 36 is responsible for managing video events based on a plurality of considerations, including but not limited to, calculated CIS scores of video events, disk storage required for a video event, predefined parameters and available disk space. Video management module 36 communicates with CIS calculation module 34, learning module 38, video data store 40, video information data store 42. The selection of which video events to retain and which events to purge may be formulated as a constraint optimization problem because the above discussed factors are all considered when determining how to handle the video events. Video management module 36 may include a constraint optimization module 79, a video clean up module 72, a mixed reality module 74 and a summary generation module 76.

Video optimization module 70 receives a CIS score for each video event, and well as video information from video information data store 42. Based on the CIS score and additional considerations such as disk space, user flags, the event capturing camera, and time stamp of a video, constraint optimization module 70 may determine how a video event is managed. Constraint module 70 may, for each video event, create one or more data structures defining all relevant considerations. Defined in each data structure may be a video event id, a CIS score, a time stamp and a user flag. The user flag may indicate a user's decision to not delete or delete a file. Video optimization module 70 may analyze the data structure of each video event and will make determinations based on available disk space, the analysis of the data structure and the analyses of other video events. Video optimization module 70 may be simplified to only consider the analysis of the data structure. For example, the user may set predefined thresholds pertaining to CIS scores. A first threshold determines whether or not a video will be purged, a second threshold may determine whether a video event will be stored in a mixed reality format, and a third threshold determines whether or not the video should be compressed or stored at a lower frame rate or bit rate. Also, user flags may override certain CIS score thresholds. A user flag may indicate a user's desire to retain a video that would otherwise be purged based on a low CIS score. In this instance, the user flag may cause the video to be stored in mixed reality format or at a lower frame rate.

A more complex video optimization module 70 may analyze the data structure for the video event in view of the available storage space and the data structures of the other video events in the system. The more complex video optimization module 70 may dynamically set the thresholds based on the available space. It may also look at correlated events and decide whether to keep a video with a low CIS score because it is highly correlated with a video having a high CIS score. It is envisioned that many other types of video optimization modules may be implemented.

Video optimization module 70 may also generate instructions for video clean-up module 72 and mixed reality module 74. Video optimization module 70 will base instructions based on video optimization module's previously discussed determinations. Video optimization module 70 may generate an instruction and retrieve all necessary parameters to execute the instruction. The instruction with parameters is then passed to either video clean-up module 72 or mixed reality module 74. For example, if video optimization module 70 is determined to exceed a first CIS threshold but not a lot of storage space remains, video optimization module 70 may set an instruction to reduce the size of the video event. If, however, a lot of storage space remains then the video may be retained in its original form. In a second example, a video has a low CIS score but is highly correlated to video with a high CIS score, then video optimization module 70 may cause the video event to be stored in a mixed reality format with the video event having a high CIS score. It is envisioned that this may be implemented using a hierarchal if-then structure where the most important factors such as CIS score are given precedent over less important factors such as time stored.

Video clean up module 72 receives instruction from constraint optimization module 70 and executes said instruction. Possible instructions include to purge a video, to retain a video, or to retain a video but in lower quality. A video event may be stored in lower quality by reducing the frame rate of the video event, the bit rate of the video event, or by compression techniques known in the art.

Mixed reality module 74 generates mixed reality video files of stored video events based on the decisions of video optimization module 70. Due to different video content provided by video cameras 12a-12n and different regulations for different application domains, a video storage scheme may not require a 24 hours a day, seven days a week continuous high frame rate video clip for each camera 12a-12n. In fact, in certain instances, all that may be required is a capturing of an overall situation among correlated cameras with a clear snap-shot of certain events. Mixed reality video files allow for events collectively captured by multiple cameras 12a-12n to be stored as a single event and possible interleaved over other images. Further, different events may be stored in different quality levels depending on the CIS score. For example, in the case of multi-level recordings, the mixed videos may be stored in the following formats: full video format including all video event data, a high resolution background and high frame rate camera images, high resolution background and low frame-rate camera images, high resolution background and object image texture mapping onto a 3D object, normal resolution background and a 3D object, or a customized combination configuration of recording quality defined by a user. Also, events captured by multiple cameras capturing the same scene from different angles may be stitched into a multiple screen display.

Mixed reality module 74 receives instruction from video optimization module 70 on how to handle certain events. Mixed reality module 74 may receive a pointer to one or more video events, one or more instruction, and other parameters such as a frame rate, time stamps for each video event, or other parameters that may be used to carry out a mixed reality mixing of videos. Based on the passed instructions from video optimization module 70, mixed reality module will generate a mixed reality video. Mixed reality module 74 may also store a background for a scene associated with a static camera in low quality while displaying the foreground objects in higher quality.

Mixed reality module 74 may also insert computer generated graphics into a scene, such as an arrow following a moving blob. Mixed reality module may generate a video scene background, such as a satellite view of the area being monitored and may interpose a foreground object that indicates a timestamp, an object type, an object size, an object location in a camera view, an object location in a global view, an object speed, an object behavior type or an object trajectory. Thus, mixed reality module may recreate a scene based on the stored video events and computer generated graphics. It is envisioned that mixed reality module 74 uses known techniques in the art to generate mixed reality videos.

Video management module 36 may also include a summary generation module 76 that generates summaries of stored video events. Summary generation module 76 receives data from video information data store and may communicate summaries to constraint optimization module 70. Summary generation module 76 may also communicate the summaries to a user via the GUI 22. Summaries can provide histograms of CIS scores of particular events or cameras, graphs focusing on storage requirements from a camera, histograms focusing on usages of particular events, or can give summaries of alarm reports.

Learning module 38 may interface with many or all of the decision making modules. Learning module 38 mines statistics corresponding to the decisions made by a user or users to learn preferences or tendencies of the user. Learning module 38 may store the statistical data corresponding to the user decisions in a data store (not shown) associated with learning module 38. Learning module 38 may use the learned tendencies to make decisions in place of the user after sufficient training of learning module 38.

During the initial learning stages, i.e. the initial stages of the system's use, the learning will be guided by the user. Learning module 38 will keep track of decisions made by the user and collect the attributes of the purged and retained video events. Learning module 38 will store said attributes as training data sets in the data store associated with learning module 38. The information relating to the users decision may be thought of as a behavior log, which may be used later by learning module 38 to determine what kind of files are typically deleted and how long an event is retained. During the evaluation phase, the system will provide a recommendation to the user as to whether to retain or purge certain video events. The system may also generate summary reports based on the CIS scores and learned data. The system's automated recommendations (via learning module 38) may be compared to the user's decisions. The system will generate an error score based on the comparison, and once the error score reaches a certain level, e.g. the system provides the correct recommendation 98% of the time, then the system may be fully automated and may require minimal user supervision.

For example, learning module 38 may observe the user's tendencies when choosing whether to retain or purge a video event from the system. Learning module 38 will monitor the CIS score as well as the sub-scores whose weighted average comprise the CIS score. Learning module 38 may also look at other considerations that are considered by the constraint optimization module 70, such as time stored and user flags. Based on the decisions, learning module 38 may mine data about the users decisions, which may be used to define the weights used for weighted average. If, for example, any video event with a high abnormality score is kept, regardless of its associated CIS score, learning module may increase the weight given to the result of abnormality score calculator 44. Relatedly, if learning module 38 sees that a particular abnormality score is typically given more accord by the user when making a determination, learning module 38 may increase the weight that is given to the particular abnormality score when calculating the overall abnormality score. Learning module 38 may use known learning techniques such as neural network models, support vector machines, and decision trees.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A system for managing a plurality of stored video segments corresponding to video events captured by a video surveillance system comprising:
a video data store that stores the plurality of video segments;
a scoring module that generates an importance score based on an event correlation score corresponding to a correlation between a video segment and other video segments having corresponding video events that correlate spatially and temporally to a video event corresponding to the video segment to be scored; and
a video management module that performs a video retention operation on the given video segment based in part on the importance score generated by scoring module.

2. The system of claim 1 wherein the event correlation score is based on a ratio corresponding to distances between an object observed in the video segment and objects observed in the other video segments and maximum possible distances between objects observed in the video segment and objects observed in the other video segments.

3. The system of claim 1 wherein the event correlation score is based on a ratio corresponding to durations of the other video segments and an amount of time corresponding to a duration of all the video segments.

4. The system of claim 1 further comprises a behavior assessment module that generates a behavior score corresponding to a video event, wherein a behavior score indicates a degree of conformity of the video event with at least one motion model defining accepted motion.

5. The system of claim 4 wherein the event correlation score is further based in part on a correlation of a behavior score of the video segment and behavior scores of the other video segments.

6. The system of claim 1 wherein the event correlation score is further based in part on whether an object in the video segment appears in the other video segments.

7. The system of claim 4 wherein the importance score is further based on the behavior score of the video segment.

8. The system of claim 1 wherein the importance score is further based on an amount of instances that the video segment has been retrieved from the video data store.

9. The system of claim 1 wherein the importance score is further based on an amount of time the video segment has been stored in the video data store.

10. The system of claim 1 wherein the importance score is further based on a user score of the video segment corresponding to a user's assessment of the video segment.

11. The system of claim 1 wherein the importance score is further based on a ratio between an of amount of times an object moves to one or more predefined target areas and a total amount of times the predefined target areas were visited.

12. The system of claim 1 wherein the importance score is further based on a predicted amount of storage required for a video event.

13. The system of claim 1 wherein the video retention operation is purging the video segment from the data store.

14. The system of claim 1 wherein the video retention operation is retaining the video segment in the data store.

15. The system of claim 1 wherein the video retention operation is reducing video quality of the video segment, wherein a size of the video segment decreases as a result of reducing the video quality of the video segment.

16. The system of claim 1 further comprising a mixed reality module operable to generate a mixed reality video using one or more video segments, wherein the generation of the mixed reality video is based in part on the importance score of the one or more video segments.

17. The system of claim 1 further comprising a learning module that adjusts the scoring module based on statistics corresponding to decisions of a user of the system.

18. The system of claim 1 wherein the video segment is received from a first camera and the other video segments are received from at least one other camera.

19. The system of claim 1 wherein the importance score is further based on a weighted average of
the event correlation score;
a behavior score corresponding to the video event indicating a degree of conformity of the video event with at least one motion model defining accepted motion;
an amount of instances when the video segment has been retrieved from the video data store;
an amount of time the video segment has been in the video data store;
a user score of the video segment corresponding to a user assessment of the video segment;
a ratio between an of amount of times an object moves to one or more predefined target areas and a total amount of times the predefined target areas were visited; and
a predicted amount of storage required for a video event.

20. A system for managing a plurality of stored video segments corresponding to video events captured by a video surveillance system comprising:
a video data store that stores the plurality of video segments;
a scoring module that generates an importance score based on a weighted average of at least two or more of the following:
1) an event correlation score corresponding to a correlation between a video segment and other video segments having corresponding video events that correlate spatially and temporally to a video event corresponding to the video segment to be scored;
2) a behavior score corresponding to the video event, wherein a behavior score indicates a degree of conformity of the video event with at least one motion model defining accepted motion;
3) an amount of instances that the video segment has been retrieved from the data store;
4) a user score of the video segment corresponding to a user assessment of the video segment;
5) a ratio between an of amount of times an object moves to one or more predefined target areas and a total amount of times the predefined target areas were visited; and
6) a predicted amount of storage required for a video event; and
a video management module that performs a video retention operation on the given video segment based in part on the importance score generated by scoring module.

21. The system of claim 20 wherein the event correlation score is based on a ratio corresponding to distances between an object observed in the video segment and objects observed in the other video segments and maximum possible distances between objects observed in the video segment and objects observed in the other video segments.

22. The system of claim 20 wherein the event correlation score is based on a ratio corresponding to durations of the other video segments and an amount of time corresponding to a duration of all the video segments.

23. The system of claim 20 wherein the event correlation score is further based in part on a correlation of the behavior score of the video segment and the behavior score of the other video segments.

24. The system of claim 20 wherein the event correlation score is further based in part on whether an object in the video segment appears in the other video segments.
